(19) United States
(12) Patent Application Publication
(10) Pub. No.: US 2011/0162947 A1
(43) Pub. Date: Jul. 7, 2011

(54) Safety switch

(76) Inventor: Albert Huang, Taipei (TW)

(21) Appl. No.: 12/654,890

(22) Filed: Jan. 7, 2010

(51) Int. Cl. H01H 23/02

(52) U.S. Cl. 200/339

(57) ABSTRACT

A safety switch has a casing, a first prong, a second prong, the rocker and a pivot switch contact unit. The rocker is mounted pivotally on the top of the casing and has an arm and an end opposite to the arm. The pivot switch contact unit has a switch contact and a pull rod. The switch contact bends upward as temperature of the switch contact increases, is pivoted to the top end of the first prong and has a proximal and distal ends. The distal end of the switch contact is connected to the arm and selectively abuts the second prong. The pull rod is connected between the end of the rocker and the proximal end of the switch contact to provides the second end of the rocker a down pulling force when the distal end of the switch contact is slightly bent and not abut the second prong.

### BACKGROUND OF THE INVENTION

1. Field of the Invention

The present invention relates to a safety switch, and more particularly to a safety switch having a pivot switch contact assembly to reverse a rocker successfully under over current condition.

2. Description of Related Art

With reference to FIG. 3, a safety switch is used to prevent over current from a circuit loop and has a casing (50), a first prong (51), a second prong (52), a switch contact (53) and a rocker (54).

The casing (50) is hollow has a top, a bottom and a cavity. The first and second prongs (51, 52) are mounted in the cavity, extend down through the bottom of the casing (50) and are connected to the circuit loop in serial. The switch contact (53) is bimetallic, bends upward as temperature of the switch contact (53) increases, is connected to the first prong (51) and has a proximal end and a distal end. The proximal end is connected securely to the first prong (51) in the cavity, and the distal end selectively abuts the second prong (52). The rocker (54) is mounted pivotally on the top of the casing (50) and has a first end, a second end and an arm (55). The arm (55) is mounted on the first end of the rocker (54), extends through the top of the casing (50) and is connected to the distal end of the switch contact (53). Pressing the first end of the rocker (54) pushes the arm (55) and the distal end down so the distal end of the switch contact (53) contacts the second prong (52). When the circuit loop has over current, temperature of the switch contact (53) increases excessively, the switch contact (53) bends due to the bimetallic characteristic, and the distal end pulls away from the second prong (52) to cut off the circuit loop. At the time, the arm is pushed upward and the rocker (54) reversely pivots since the rocker (54) is mounted pivotally on the top of the casing (50). Therefore, a user checks a direction of the rocker (54) to determine whether the circuit loop is cut off.

Based on the foregoing description, the switch contact controls an action of the rocker (54) by the bimetallic characteristic, so the switch contact (53) does not have enough force to push the arm (55) in a specific temperature but the circuit loop has been cut off. Therefore, the user does not only check the direction of the rocker (54) to determine that the circuit is cut off.

To overcome the shortcomings, the present invention provides a safety switch to mitigate or obviate the aforementioned problems.

### SUMMARY OF THE INVENTION

The main objective of the present invention is to provide a safety switch having a pivot switch contact to switch rocker successfully.

The safety switch in accordance with the present invention has a casing, a first prong, a second prong, the rocker and a pivot switch contact unit. The rocker is mounted pivotally on the top of the casing and has an arm and an end opposite to the arm. The pivot switch contact unit has a switch contact and a pull rod. The switch contact bends upward as temperature of the switch contact increases, is pivoted to the top end of the first prong and has a proximal and distal ends. The distal end of the switch contact is connected to the arm and selectively abuts the second prong. The pull rod is connected between the end of the rocker and the proximal end of the switch contact to provides the second end of the rocker a down pulling force when the distal end of the switch contact is slightly bent and not abut the second prong.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view in partial of a safety switch in accordance with the present invention;

FIG. 2 is an operational view of the safety switch of FIG. 1; and

FIG. 3 is a cross sectional view in partial of a conventional safety switch in accordance with the prior art.

### DETAILED DESCRIPTION OF THE PREFERRED EMBODIMENT

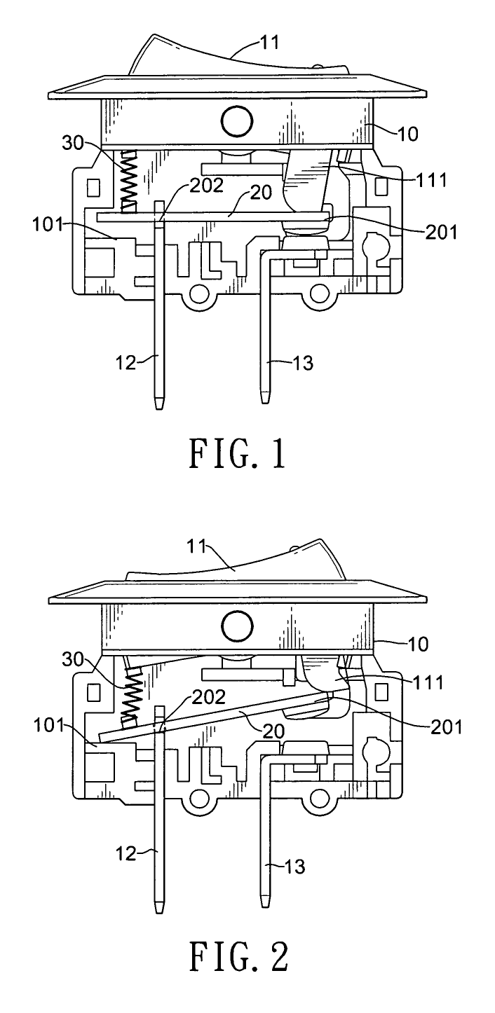

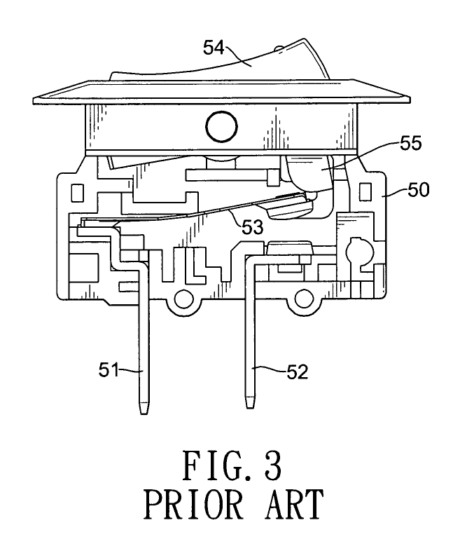

With reference to FIGS. 1 and 2, a safety switch in accordance with the present invention has a casing (10), a first prong (12), a second prong (13), the rocker (11) and a pivot switch contact unit.

The casing (10) is hollow and has a top, a bottom, a cavity and a support (101) formed in the cavity.

The first and second prongs (12, 13) are mounted in the cavity, next to the support (101), extend down through the bottom of the casing (10) and are connected to a circuit loop in serial. The first prong (12) has a top end.

The rocker (11) is mounted pivotally on the top of the casing (10) and has a first end, a second end and an arm (111). The arm (111) is mounted on the first end of the rocker (11), extends through the top of the casing (11) and received in the cavity.

The pivot switch contact unit is received in the cavity of the casing (11) and has a switch contact (20) and a pull rod (30). The switch contact (20) is bimetallic, bends upward as temperature of the switch contact (20) increases, is mounted pivotally to the top end of the first prong (12) and has a proximal end and a distal end. In the preferred embodiment, In the preferred embodiment, a through hole (202) is defined through a portion of the switch contact (20) that pivots to the top end of the first prong (12). The through hole (202) allows the top end of the first prong (12) to pass through and pivot to the first prong (12). The distal end of the switch contact (20) is connected to the arm (111) and selectively abuts the second prong (13). The pull rod (30) is connected between the second end of the rocker (11) and the proximal end of the switch contact (20). In the preferred embodiment, the pull rod (30) is a compressed spring. In addition, the proximal end of the switch contact (20) corresponds to the support of the casing (10).

In a case, the safety switch is connected to a circuit loop in serial to cut off the circuit loop when an over current is occurred. In a normal condition of the circuit loop, the first end of the rocker (11) pushes the arm (111) and the distal end of the switch contact (20) down so the distal end of the switch contact (20) contacts the second prong (13). Once the over current is occurred in the circuit loop, temperature of the switch contact (20) increases excessively, the switch contact (20) bends due to the bimetallic characteristic, and the distal end pulls away from the second prong (13) to cut off the circuit loop. At the time, the proximal end moves downward since the leverage constituted by pivoting the switch contact (20) to the first prong (13) and the second end of the rocker (11) is pulled down by the pull rod (30). Then the proximal end of the switch contact (20) abuts on the support of the casing (10).

Therefore, the arm of the rocker is quickly pushed upward by the distal end and the pull rod to reverse a direction of the rocker. Therefore, once the distal end of the switch contact is slightly bent and is not abut the second prong, the pull rod provides the second end of the rocker a pulling force to ensure the direction of the rocker is reversed. The user only checks the direction of the rocker to know whether the circuit loop is cut off.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A safety switch comprising:
a casing being hollow, mounted on a power socket and having a top, a bottom and a cavity;
a first and second prongs mounted in the cavity and extend down through the bottom of the casing, wherein the first prong has a top end;
a rocker mounted pivotally on the top of the casing and having
a first and a second ends; and
an arm mounted on the first end of the rocker, extending through the top of the casing and received in the cavity; and
a pivot switch contact unit received in the cavity of the casing and having
a switch contact being bimetallic, bending upward as temperature of the switch contact increases and having
a proximal end mounted pivotally to the top end of the first prong; and
a distal end connected to the arm and selectively abutted the second prong; and
a pull rod connected between the second end of the rocker and the proximal end of the switch contact.

2. The safety switch as claimed in claim 1, wherein the pull rod is a compressed spring.

3. The safety switch as claimed in claim 1, wherein
the first prong has a through hole that is laterally defined through the top end of the first prong; and
the proximal end of the switch contact passes through the through hole and mounted pivotally to the top end of the first prong.

4. The safety switch as claimed in claim 2, wherein
the first prong has a through hole that is laterally defined through the top end of the first prong; and
the proximal end of the switch contact passes through the through hole and mounted pivotally to the top end of the first prong.

5. The safety switch as claimed in claim 1, wherein the casing further comprises a support formed in the cavity to selectively abut the proximal end of the switch contact.

6. The safety switch as claimed in claim 2, wherein the casing further comprises a support formed in the cavity to selectively abut the proximal end of the switch contact.

7. The safety switch as claimed in claim 3, wherein the casing further comprises a support formed in the cavity to selectively abut the proximal end of the switch contact.

8. The safety switch as claimed in claim 4, wherein the casing further comprises a support formed in the cavity to selectively abut the proximal end of the switch contact.
